(19) United States
(12) Patent Application Publication
(10) Pub. No.: US 2021/0029990 A1
(43) Pub. Date: Feb. 4, 2021

(54) HERBICIDAL COMPOSITION

(71) Applicant: Lamberti SPA, Albizzate (IT)

(72) Inventors: Rocco DI MODUGNO, Seregno (IT); Andrea BALESTRINI, Sugar Land, TX (US); Dario FORNARA, Novara (IT); Lauren Blair, Albizzate (IT); Alessandro LUGARI, Opera (IT); Giovanni Floridi, Novara (IT); Giuseppe LI BASSI, Gavirate (IT)

(73) Assignee: Lamberti SPA, Albizzate (IT)

(21) Appl. No.: 16/639,322

(22) PCT Filed: Aug. 9, 2018
(86) PCT No.: PCT/EP2018/071701

§ 371 Date: Feb. 14, 2020

(30) Foreign Application Priority Data
Aug. 24, 2017 (IT) 102017000095717

(51) Int. Cl. A01N 25/30; A01N 57/20

(52) U.S. Cl. CPC A01N 25/30; A01N 57/20

(57) ABSTRACT

Stable herbicidal compositions containing an ethoxylated esteramine as adjuvant.

### FIELD OF THE INVENTION

The present invention relates to herbicidal compositions and in particular to stable herbicidal compositions containing glyphosate or an agriculturally acceptable salt thereof and an adjuvant.

### BACKGROUND OF THE ART

Glyphosate (N-(phosphonomethyl)glycine in acid or salt form) is one of the most frequently applied herbicides for non-selective control of weeds and unwanted plants in agriculture and in non-agricultural areas. It works by inhibiting 5-enolpyruvylshikimate-3-phosphate synthase (EPSPS), an enzyme of the aromatic acids biosynthetic pathway, thus preventing the synthesis of essential aromatic amino acids that are needed for protein biosynthesis.

The acid form of glyphosate is poorly soluble in water and for this reason glyphosate is typically commercialized as a salt that exhibits sufficiently high solubility in water to provide concentrated herbicidal formulations that are diluted by the end-user on field. Commonly used salts of glyphosate include sodium salt, potassium salt, ammonium salt, sulphonium salts such as trimethylsulphonium, amine salts such as monoisopropylamine, dimethylamine, diamines (for example, ethylenediamine) and alkanolamines (for example, monoethanolamine).

Glyphosate is usually applied by the end user as a diluted spray aqueous solution. Diluted spray aqueous solutions of glyphosate typically include at least one surfactant which acts as adjuvant. The presence of a surfactant is highly desirable since surfactants reduce the interface tension between the aqueous spray and the material (foliage) to be treated (i.e. they improve wetting), thus favoring the spreading of droplets on the treated surface, the penetration of the active ingredient into the materials and the overall bioefficacy of the solution.

The original glyphosate patent U.S. Pat. No. 3,799,758, which is fully incorporated herein by reference, includes in the herbicidal formulation a surface-active adjuvant, comprising, among others: alkyl benzene sulfonates or alkyl naphthalene sulfonates, sulfated fatty alcohols, amines or acid amines derivatives, esters of sodium sulfosuccinate, sulfonated vegetable oils and ethoxylated alkyl amine, the latter being preferred in the majority of the commercial formulations due to its low cost and reasonable efficiency.

Alkyl amine ethoxylates, and in particular ethoxylated tallow amine, are most frequently used as adjuvants with pesticides, in particular as adjuvants for glyphosate. Various other alkyl amine based surfactants have been described to provide excellent bioefficacy to glyphosate. However, these surfactants are hazardous and can be serious irritants to eyes, skin and the respiratory tract, and highly toxic to plants and animals, especially aquatic plants and animals, even at low concentrations.

In addition, it is becoming more and more desirable to increase the active herbicide concentration in formulations so that a given dose of herbicide can be provided in a smaller liquid volume resulting in advantages in terms of transport, storage, handling and container disposal. In terms of glyphosate formulations, concentrations of at least 480 g/L are desired. Highly concentrated herbicide formulations have a tendency to crystallise and exhibit phase separation when stored for prolonged periods at low temperatures. Traditional surfactants which attempt to accommodate high concentration glyphosate formulations are problematic in that the high concentration of surfactant required causes immiscibility between the surfactant and the glyphosate. In the field of the alternatives to classical adjuvants such as tallow amine ethoxylate, EP 1289362 describes esteramines obtained from an ethoxylated alcohol that has been carboxymethylated and then esterified with a tertiary hydroxylamine (alkanolamine), and amidoamines obtained by reaction between a fatty acid or a fatty acid methyl ester and a diamine.

We have now discovered that ethoxylated esteramines, which are the reaction product of a saturated or unsaturated C₆-C₃₀ aliphatic monocarboxylic acid and a tertiary hydroxylamine, wherein the ethoxylation is conducted directly on the tertiary hydroxylamine before the esterification or on the product of the esterification reaction, can be used to prepare stable herbicidal formulations containing glyphosate or an agriculturally acceptable salt thereof. This is especially surprising, because not only said ethoxylated esteramines are as effective adjuvants as tallow amine ethoxylate, but also they show a much better ecotoxicological profile.

### SUMMARY OF THE INVENTION

It is therefore an object of the present invention an aqueous herbicide composition containing from 1 to 30% by weight (wt %) of an ethoxylated esteramine, wherein said ethoxylated esteramine has the formula (I):

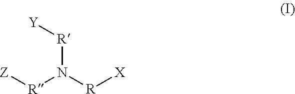

wherein:
a) R, R′ and R″ are each independently alkylene group having from 1 to 8 carbon atoms
b) X, Y and Z are selected among H, O—(CH₂CH₂O)ₙH, O—(CH₂CH₂O)ₙ—COR′″ or O—COR′″ and one among X, Y and Z is O—(CH₂CH₂O)ₙ—COR′″ or O—COR′″
   wherein n=1-40, and R′″ is a saturated or unsaturated C₆-C₃₀ alkyl group; provided that:
i) when one among X, Y or Z is O—(CH₂CH₂O)ₙ—COR′″, the other two substituents are each independently H or O—(CH₂CH₂O)ₙH
ii) when one among X,Y or Z is O—COR′″, the other two substituents are H or O—(CH₂CH₂O)ₙH and at least one of them is O—(CH₂CH₂O)ₙH

A further object of the invention is a method for killing or controlling the growth of weeds which includes applying on the fields a diluted aqueous herbicidal composition containing from 0.01 to 3 wt % of glyphosate (a.e.) or an agriculturally acceptable salt thereof and an ethoxylated esteramine of formula (I) as adjuvant, in an amount sufficient to kill or control the growth of the weeds.

It is another object of the present invention a diluted sprayable herbicidal composition (tank mix) comprising from 0.01 to 10% wt, preferably from 0.01 to 5% wt of at least one herbicide, and from 0.01 to 5% wt, preferably from 0.01 to 3% wt of an ethoxylated esteramine of formula (I).

Throughout the specification, unless otherwise indicated, the amounts of glyphosate and salts thereof are provided on an acid equivalent basis (a.e.).

### DETAILED DESCRIPTION OF THE INVENTION

Preferably, the aqueous herbicide composition of the invention contains from 100 to 750 g/l, preferably from 300 to 600 g/l (as acid equivalents (a.e.)) of glyphosate or an agriculturally acceptable salt thereof and from to 2 to 10% by weight (wt %) of an ethoxylated esteramine, wherein said ethoxylated esteramine has the formula (I):

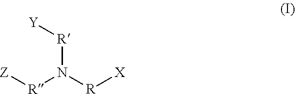

wherein:
a) R, R′ and R″ are each independently alkylene group having 2 carbon atoms
b) X, Y and Z are selected among O—(CH₂CH₂O)ₙH, O—(CH₂CH₂O)ₙ—COR′″ or O—COR′″ and one among X, Y and Z is O—(CH₂CH₂O)ₙ—COR′″ or O—COR′″
   wherein n=3-20, preferably 10-20, and R′″ is a saturated or unsaturated C₁₆-C₂₂ alkyl group;

provided that:
i) when one among X, Y or Z is O—(CH₂CH₂O)ₙ—COR′″, the other two substituents are both O—(CH₂CH₂O)ₙH
ii) when one among X,Y or Z is O—COR′″, the other two substituents are both O—(CH₂CH₂O)ₙH

According to the invention, the ethoxylated esteramines used as adjuvants for glyphosate compositions are the reaction product of a saturated or unsaturated C₆-C₃₀ aliphatic monocarboxylic acid and a tertiary hydroxylamine, wherein the ethoxylation is conducted directly on the tertiary hydroxylamine before the esterification or on the product of the esterification reaction.

Examples of C₆-C₃₀ aliphatic unsaturated monocarboxylic acids suitable for the present invention include both unsaturated and polyunsaturated aliphatic carboxylic acids with from 6 to 30 carbon atoms. Examples of these acids are palmitoleic acid, oleic acid, linoleic acid, linolenic acid, arachidonic acid, and the like.

Examples of C₆-C₃₀ aliphatic saturated monocarboxylic acids include decanoic acid, lauric acid, myristic acid, palmitic acid, stearic acid, behenic acid, and the like.

Mixtures of C₆-C₃₀ saturated and unsaturated aliphatic monocarboxylic acids can be also used.

Also purified waste vegetable oils are useful sources of aliphatic monocarboxilic acids.

Mixtures of monocarboxylic acids derived from natural oils, such as coconut oil, mustard seed oil, palm oil, olein, soy oil, canola oil, tall oil, sunflower oil and mixture thereof are preferred. Mixtures derived from tall oil are particularly preferred.

In particular, the most preferred tall oil fatty acids are those having a certain amount of resin acids, that are also able to react with the tertiary hydroxylamine or ethoxylated tertiary hydroxylamine; preferably the tall oil fatty acids are those having less than 6 wt %, more preferably from 0.5 to 6 wt % of resin acids.

Mixtures of saturated and unsaturated aliphatic C₆-C₃₀ monocarboxylic acids obtained as by-product in the process of the biodiesel production are also suitable.

According to the invention, the tertiary hydroxylamine is selected among trialkanolamines, monoalkyldialkanolamines and dialkylmonoalkanolamines, wherein the alkyl and hydroxyalkyl substituents have from 1 to 8 carbon atoms.

Specific examples of said tertiary hydroxylamines are triethanolamine, N-methyl-diethanolamine, N-ethyl-diethanolamine, N-propyl-diethanolamine, N-butyl-diethanolamine, N,N-dimethyl-ethanolamine, N,N-diethyl-ethanolamine, N,N-diisopropyl-ethanolamine, N,N-dibutyl-ethanolamine and N,N-dimethyl-isopropanolamine.

Preferably, the tertiary hydroxylamine is a trialkanolamnine. The most preferred trialkanolamine is triethanolamine.

As stated above, the ethoxylated esteramines of the invention are the reaction product of a saturated or unsaturated C₆-C₃₀ aliphatic monocarboxylic acid and a tertiary hydroxylamine, wherein the ethoxylation is conducted directly on the tertiary hydroxylamine before the esterification or on the product of the esterification reaction. Preferably, the tertiary hydroxylamine undergoes ethoxylation and then is esterified with a saturated or unsaturated C₆-C₃₀ aliphatic monocarboxylic acid, by reacting them in a molar ratio of 1:1, to minimize the formation of diesters and other by-products, typically polyethylene glycol monoesters and diesters that could be detrimental to the product performances.

According to the invention, the herbicidal composition contains a herbicide, which is glyphosate, and the above mentioned ethoxylated esteramine as adjuvant.

Any agriculturally-acceptable water-soluble salt of glyphosate may be used in the herbicidal compositions according to the practice of this invention.

Glyphosate is an organic compound that contains three acidic protonable groups, and in its acid form is relatively insoluble in water. Therefore, glyphosate is normally formulated and applied as a water-soluble salt. Although monobasic, dibasic, and tribasic salts of glyphosate can be made, it has generally been preferred to formulate and apply glyphosate in the form of a monobasic salt, for example as a potassium or monoalkyl ammonium salt. Suitable salts include salts of isopropylamine; sodium; potassium; ammonium; mono-, di-, tri- and tetra-C₁₋₄-alkylammonium; mono-, di- and tri-C₁₋₄-alkanolammonium; mono-, di- and tri-C₁₋₄-alkylsulfonium; and sulfoxonium. Mixtures of salts can also be useful in certain formulations.

The preferred forms of glyphosate in the herbicidal compositions are the isopropylamine salt of glyphosate and the potassium salt of glyphosate.

Beside the ethoxylated esteramine and glyphosate, the herbicidal composition of the invention may further contain, as further ingredients:
other surfactants, such as cationic, anionic, non-ionic, and amphoteric surfactants, such as nonionic or anionic alkylpolyglycosides, alkoxylated fatty alcohols or amines, anionic esters of (alkoxylated) fatty alcohols, C₆-C₁₈ alkyldimethyl betaine;
other herbicides, such as salts of glufosinate, bentazon, fomesafen, 2,4-D and its derivatives, dicamba, MCPA, MCPP, MCPB, paraquat, clopyralid, dichlorprop, imazalil, picloram, diquat, terbuthylazine, florasulam, isoproturon, diuron, diflufenican and mixtures thereof;
other biocidally active ingredients or compositions, for example insecticides, fungicides, bactericides, acaricides, nematicides and/or plant growth regulators, in order to broaden the spectrum of activity;
fertilizers (nitrogen source), such as ammonium sulfate, ammonia solutions, ammonium nitrate, ammonium hydrogen sulphate, ammonium acetate, ammonium formiate, ammonium oxalate, ammonium carbonate, ammonium hydrogen carbonate, ammonium thiosulfate, ammonium phosphate, diammonium hydrogen phosphate, ammonium dihydrogen phosphate, sodium ammonium hydrogen phosphate, ammonium thiocyanate, urea, thiourea and their blends;
water soluble organic solvents, such as glycerol, ethylene glycol, propylenglycole, dipropylene glycol methyl ether (Dowanol DPM), dipropylene glycol, butyldiglycol, dimethylsulfoxide (DMSO), N-methyl-2-pyrrolidone, dibutoxymethane (Butylal), methanol, ethanol, isopropanol, ethyl lactate (Purasolv), propylene carbonate and mixtures thereof;
other usual additives of agrochemical compositions, such as antifoam agents, antifreeze agents, dyes, stabilizers, buffers, thickeners, flow enhancers, wetting agents, lubricants, fillers, drift control agents, stickers, evaporation retardants, preservatives and the like.

It is preferred that, when the composition of the invention contains additives, such additional components are environmentally friendly, substantially non-toxic to aquatic life, and have acceptable efficacy.

The herbicidal composition of the present invention may be a concentrated aqueous composition or a diluted, ready to use, spray aqueous solution.

The concentrated aqueous herbicidal composition typically contains from 100 to 750 g/l, preferably from 300 to 600 g/l as acid equivalent of salts of glyphosate and from 1 to 30% by weight, preferably from 2 to 10% by weight of the ethoxylated esteramine. The concentrated aqueous herbicidal composition of the present invention comprises at least 10% by weight, preferably from 20 to 40% by weight, of water. The concentrated aqueous herbicidal composition of the present invention may generally be prepared by blending the ethoxylated esteramine and optionally the further ingredients listed above and then mixing it with glyphosate salt solutions and water, in a suitable mixing vessel equipped with a stirring unit, such as a blender. In a preferred embodiment, the concentrated aqueous herbicidal composition exhibits a Brookfield® viscosity at 25° C. of less than 1500 mPa*s and in particular below 300 mPa·s.

The diluted herbicidal composition of the present invention is obtained by dilution with water of the concentrated composition and it is a herbicidal aqueous formulation, preferably a solution, possibly ready to use by spray application, that includes from 0.01% to 3% by weight a.e. of glyphosate, the ethoxylated esteramine as adjuvant and, optionally, the further ingredients listed above, such as other active ingredients, fertilizers, solvents, micronutrients, surfactants and/or other additives commonly used in agrochemical compositions.

The present invention provides also a method for killing or controlling the growth of weeds by applying on the fields the aqueous herbicidal composition containing glyphosate and the adjuvant according to the present invention in diluted form, tipically comprising from 0.01 to 3 wt % of glyphosate (a.e.), in an amount sufficient to kill or control the growth of the weeds. The herbicidal compositions of the present invention are typically applied in diluted form as foliar non selective herbicides or in combination with a post-emergence herbicide.

The method of the present invention is useful for combating and/or preventing unwanted plants among crops of useful plants. The method of the invention is also suitable combating and/or preventing unwanted plants in places physically distinct from crop areas, e.g., non-crop lands, along unplanted roadsides or under power lines.

Another object of the present invention is represented by diluted sprayable herbicidal compositions (tank mixes) comprising from 0.01 to 10% wt, preferably from 0.01 to 5% wt of at least one herbicide, and from 0.001 to 5% wt, preferably from 0.01 to 3% wt of an ethoxylated esteramine of formula (I). Said diluted sprayable herbicidal compositions are obtained by adding the ethoxylated esteramine of formula (I) to water or other suitable carrier, either before or after the formulated herbicide. Alternatively, the formulated herbicide and/or the ethoxylated esteramine of formula (I) may be previously diluted and then mixed.

Said sprayable herbicide tank mixes comprise herbicidal active compounds, such as Acetochlor, Acibenzolar, Acibenzolar-S-methyl, Acifluorfen, Acifluorfen-sodium, Aclonifen, Alachlor, Allidochlor, Alloxydinn, Alloxydinn-sodium, Ametryn, Amicarbazone, Amidochlor, Amidosulfuron, Aminocyclopyrachlor, Aminopyralid, Amitrole, Ammonium sulfamat, Ancymidol, Anilofos, Asulam, Atrazine, Azafenidin, Azimsulfuron, Aziprotryn, Beflubutamid, Benazolin, Benazolin-ethyl, Bencarbazone, Benfluralin, Benfuresate, Bensulide, Bensulfuron, Bensulfuron-methyl, Bentazone, Benzfendizone, Benzobicyclon, Benzofenap, Benzofluor, Benzoylprop, Bicyclopyrone, Bifenox, Bispyribac, Bispyribac-sodium, Bromacil, Bromobutide, Bromofenoxim, Bromoxynil, Bromuron, Buminafos, Busoxinone, Butachlor, Butafenacil, Butamifos, Butenachlor, Butralin, Butroxydim , Butylate, Cafenstrole, Carbetamide, Carfentrazone, Carfentrazone-ethyl, Chlomethoxyfen, Chloramben, Chlorazifop, Chlorazifop-butyl, Chlorbromuron, Chlorbufam, Chlorfenac, Chlorfenac-sodium, Chlorfenprop, Chlorflurenol, Chlorflurenol-methyl, Chloridazon, Chlorimuron, Chlorimuron-ethyl, Chlormequat-chloride, Chlornitrofen, Chlorophthalim, Chlorthal-dimethyl, Chlorotoluron, Chlorsulfuron, Cinidon, Cinidon-ethyl, Cinmethylin, Cinosulfuron, Clethodim (C10), Clodinafop, Clodinafop-propargyl, Clofencet, Clomazone, Clomeprop, Cloprop, Clopyralid (C1), Cloransulam, Cloransulam-methyl, Cumyluron, Cyanamide, Cyanazine, Cyclanilide, Cycloate, Cyclosulfamuron, Cycloxydim (C11), Cycluron, Cyhalofop, Cyhalofop-butyl, Cyperquat, Cyprazine, Cyprazole, 2,4-D (and salts or esters thereof such as 2,4-D-butotyl, 2,4-D-butyl, 2,4-D-dimethylammonium, 2,4-D-diolamine, 2,4-D-ethyl, 2,4-D-ethylhexyl, 2,4-D-isobutyl, 2,4-D-isoctyl, 2,4-D-isopropyl, 2,4-D-isopropylammonium, 2,4-D-sodium, 2,4-D-triisopropanolammonium, 2,4-D-trolamine), 2,4-DB, Dalapon, Daminozide, Dazomet, n-Decanol, Desmedipham, Desmetryn, Detosyl-Pyrazolate (DTP), Diallate, Dicamba (and salts or esters thereof such as Dicamba-butotyl, Dicamba diglycolamine salt, Dicamba-dimethylammonium, Dicamba-diolamine, Dicamba-isopropylammonium, Dicamba-potassium, Dicamba-sodium, Dicamba-trolamine), Dichlobenil, Dichlorprop, Dichlorprop-P, Diclofop, Diclofop-methyl, Diclofop-P-methyl, Diclosulam, Diethatyl, Diethatyl-ethyl, Difenoxuron, Difenzoquat, Diflufenican, Diflufenzopyr, Diflufenzopyr-sodium, Dimefuron, Dikegulac-sodium, Dimefuron, Dimepiperate, Dimethachlor (C2), Dimethametryn, Dimethenamid, Dimethenamid-P, Dimethipin, Dimetrasulfuron, Dinitramine, Dinoseb, Dinoterb, Diphenamid, Dipropetryn, Diquat, Diquat-dibromide, Dithiopyr, Diuron, DNOC, Eglinazine-ethyl, Endothal, EPTC, Esprocarb, Ethalfluralin, Ethametsulfuron, Ethametsulfuron-methyl, Ethephon, Ethidimuron, Ethiozin, Ethofumesate, Ethoxyfen, Ethoxyfen-ethyl, Ethoxysulfuron, Etobenzanid, F-5331, i.e. N-[2-Chloro-4-fluoro-5-[4-(3-fluoropropyl)-4,5-dihydro-5-oxo-1H-tetrazol-1-yl]-phenyl]-ethan sulfonamide, F-7967, i.e. 3-[7-Chloro-5-fluoro-2-(trifluoromethyl)-1H-benzimidazol-4-yl]-1-methyl-6-(trifluormethyl)pyrimidin-2,4(1H,3H)-dione, Fenoprop, Fenoxaprop, Fenoxaprop-P, Fenoxaprop-ethyl, Fenoxaprop-P-ethyl (C3), Fenoxasulfone, Fentrazamide, Fenuron, Flamprop, Flamprop-M-isopropyl, Flamprop-M-methyl, Flazasulfuron, Florasulam, Fluazifop, Fluazifop-P, Fluazifop-butyl, Fluazifop-P-butyl, Fluazolate, Flucarbazone, Flucarbazone-sodium, Flucetosulfuron, Fluchloralin, Flufenacet (Thiafluamide), Flufenpyr, Flufenpyr-ethyl, Flumetralin, Flumetsulam, Flumiclorac, Flumiclorac-pentyl, Flumioxazin, Flumipropyn, Fluometuron, Fluorodifen, Fluoroglycofen, Fluoroglycofen-ethyl, Flupoxam, Flupropacil, Flupropanate, Flupyrsulfuron, Flupyrsulfuron-methyl-sodium, Flurenol, Flurenol-butyl, Fluridone, Flurochloridone, Fluroxypyr, Fluroxypyr-meptyl, Flurprimidol, Flurtamone, Fluthiacet, Fluthiacet-methyl, Fluthiamide, Fomesafen, Foramsulfuron, Forchlorfenuron, Fosamine, Furyloxyfen, Glufosinate, Glufosinate ammonium, Glyphosate, Glyphosate-diammonium, Glyphosate-isopropylammonium, Glyphosate-potassium, H-9201, i.e. O-(2,4-Dimethyl-6-nitrophenyl)-O-ethyl-isopropyl phosphoramidothioate, Halosafen, Halosulfuron, Halosulfuron-methyl, Haloxyfop, Haloxyfop-p (C4), Haloxyfop-ethoxyethyl, Haloxyfop-P-ethoxyethyl, Haloxyfop-methyl, Haloxyfop-P-methyl, Hexazinone, HW-02, i.e. 1-(Dimethoxyphosphoryl)-ethyl(2,4-dichlorophenoxy)acetate, Imazamethabenz, Imazamethabenz-methyl, Imazamox (C9), Imazamox-ammonium, Imazapic, Imazapyr, Imazapyr-isopropylammonium, Imazaquin, Imazaquin-ammonium, Imazethapyr, Imazethapyr-ammonium, Imazosulfuron, Inabenfide, Indanofan, Indaziflam, Indolacetic acid (IAA), 4-Indol-3-yl-butirric acid (IBA), Iodosulfuron, Iodosulfuron-methyl-sodium, Ioxynil, Ipfencarbazone, Isocarbamid, Isopropalin, Isoproturon, Isouron, Isoxaben, Isoxachlortole, Isoxaflutole, Isoxapyrifop, KUH-043, i.e. 3-({[5-(Difluoromethyl)-1-methyl-3-(trifluoromethyl)-1H-pyrazol-4-yl]methyl}sulfonyl)-5,5-dimethyl-4,5-dihydro-1,2-oxazole, Karbutilate, Ketospiradox, Lactofen, Lenacil, Linuron, MCPA, MCPB, MCPB-methyl, -ethyl and -sodium, Mecoprop, Mecoprop-sodium, Mecoprop-butotyl, Mecoprop-P-butotyl, Mecoprop-P-dimethylammoniunn, Mecoprop-P-2-ethylhexyl, Mecoprop-P-potassium, Mefenacet, Mefluidide, Mepiquat-chlorid, Mesosulfuron, Mesosulfuron-methyl, Mesosulfuron-methyl-Na, Mesotrione, Methabenzthiazuron, Metam, Metamifop, Metamitron, Metazachlor (C5), Metazasulfuron, Methazole, Methiopyrsulfuron, Methiozolin, Methoxyphenone, Methyldymron, 1-Methylcyclopropen, Methylisothiocyanat, Metobenzuron, Metobromuron, Metolachlor, S-Metolachlor, Metosulam, Metoxuron, Metribuzin, Metsulfuron, Metsulfuron-methyl, Molinate, Monalide, Monocarbamide, Monocarbamide-dihydrogensulfat, Monolinuron, Monosulfuron, Monosulfuron-ester, Monuron, MT-128, i.e. 6-Chloro-N-[(2E)-3-chloroprop-2-en-1-yl]-5-methyl-N-phenylpyridazin-3-amine, MT-5950, i.e. N-[3-Chloro-4-(1-methylethyl)-phenyl]-2-methylpentanamide, NGGC-011, Naproanilide, Napropamide (C6), Naptalam, NC-310, i.e.4-(2,4-Dichlorobenzoyl)-1-methyl-5-benzyloxypyrazole, Neburon, Nicosulfuron, Nipyraclofen, Nitralin, Nitrofen, Nitrophenolat-sodium (isomer mixture), Nitrofluorfen, Nonansaure, Norflurazon, Orbencarb, Orthosulfamuron, Oryzalin, Oxadiargyl, Oxadiazon, Oxasulfuron, Oxaziclomefone, Oxyfluorfen, Paclobutrazol, Paraquat, Paraquat-dichlorid, Pendimethalin, Pendralin, Penoxsulam, Pentanochlor, Pentoxazone, Perfluidone, Pethoxamid, Phenisopham, Phenmedipham, Phenmedipham-ethyl, Picloram, Picolinafen, Pinoxaden, Piperophos, Pirifenop, Pirifenop-butyl, Pretilachlor, Primisulfuron, Primisulfuron-methyl, Probenazole, Profluazol, Procyazine, Prodiamine, Prifluraline, Profoxydim, Prohexadione, Prohexadione-calcium, Prohydrojasmone, Prometon, Prometryn, Propachlor, Propanil, Propaquizafop, Propazine, Propham, Propisochlor, Propoxycarbazone, Propoxycarbazone-sodium, Propyrisulfuron, Propyzamide, Prosulfalin, Prosulfocarb, Prosulfuron, Prynachlor, Pyraclonil, Pyraflufen, Pyraflufen-ethyl, Pyrasulfotole, Pyrazolynate (Pyrazolate), Pyrazosulfuron, Pyrazosulfuron-ethyl, Pyrazoxyfen, Pyribambenz, Pyribambenz-isopropyl, Pyribambenz-propyl, Pyribenzoxim, Pyributicarb, Pyridafol, Pyridate (C7), Pyriftalid, Pyriminobac, Pyriminobac-methyl, Pyrimisulfan, Pyrithiobac, Pyrithiobac-sodium, Pyroxasulfone, Pyroxsulam, Quinclorac, Quinmerac, Quinoclamine, Quizalofop, Quizalofop-ethyl, Quizalofop-P, Quizalofop-P-ethyl, Quizalofop-P-tefuryl, Rimsulfuron, Saflufenacil, Secbumeton, Sethoxydim, Siduron, Simazine, Simetryn , SN-106279, i.e. Methyl-(2R)-2-({7-[2-chloro-4-(trifluoromethyl) phenoxy]-2-naphthyl}oxy) propanoate, Sulcotrione, Sulfallate (CDEC), Sulfentrazone, Sulfonneturon, Sulfonneturon-methyl, Sulfosate (Glyphosate-trimesium), Sulfosulfuron, SYN-523, SYP-249, i.e. 1-Ethoxy-3-methyl-1-oxobut-3-en-2-yl-5-[2-chloro-4-(trifluoromethyl)phenoxy]-2-nitrobenzoate, SYP-300, i.e. 1-[7-Fluoro-3-oxo-4-(prop-2-in-1-yl)-3,4-dihydro-2H-1,4-benzoxazin-6-yl]-3-propyl-2-thioxoimidazolidin-4,5-dione, Tebutam, Tebuthiuron, Tecnazene, Tefuryltrione, Tembotrione, Tepraloxydim, Terbacil, Terbucarb, Terbuchlor, Terbumeton, Terbuthylazine, Terbutryn, Thenylchlor, Thiafluamide, Thiazafluron, Thiazopyr, Thidiazimin, Thidiazuron, Thiencarbazone, Thiencarbazone-methyl, Thifensulfuron, Thifensulfuron-methyl, Thiobencarb, Tiocarbazil, Topramezone, Tralkoxydim, Triallate, Triasulfuron, Triaziflam, Triazofenamide, Tribenuron, Tribenuron-methyl, Trichloroacetic acid (TCA), Triclopyr, Tridiphane, Trietazine, Trifloxysulfuron, Trifloxysulfuron-sodium, Trifluralin (C8), Triflusulfuron, Triflusulfuron-methyl, Trimeturon, Trinexapac, Trinexapac-ethyl, Tritosulfuron, Tsitodef, Uniconazole, Uniconazole-P, Vernolate, ZJ-0862, i.e.3,4-Dichloro-N-{2-[(4,6-dimethoxypyrimidin-2-yl)oxy]benzyl}aniline, salts thereof and mixture thereof.

Preferred herbicidal active compounds are Glyphosate, 2,4-D, Dicamba, Clethodim, Metribuzine or derivatives thereof.

Other biologically active ingredients such as other pesticides, plant growth regulators, algicides, fungicides, bactericides, viricides, insecticides, acaricides, nematicides may be added as partners in the sprayable herbicidal tank mixes.

The diluted sprayable herbicidal compositions (tank mixes) of the invention may further include at least one oil selected among: vegetable oil, modified vegetable oil, seed oil, modified soybean oil (e.g., methylated soybean oil), modified palm oil, modified rapeseed oil, crop oil concentrate, petroleum hydrocarbons, mineral oil, paraffinic oil, naphthenic oil, aromatic oil, emulsified petroleum distillates, unsaturated fatty acids, paraffin oil, tall oil. Modified oils may include oils that are, for instance, methylated, ethylated, propylated, or butylated.

The diluted sprayable herbicidal compositions (tank mixes) of the invention may additionally comprise other conventional additives, including thickeners, flow enhancers, wetting agents, buffers, lubricants, fillers, drift control agents, deposition enhancers, evaporation retardants, frost protecting agents, insect attracting odor agents, UV protecting agents, fragrances, anti-foam agents and the like.

The following Examples illustrate the preparation of the ethoxylated esteramines of the invention. They also serve to illustrate the comparable bioefficacy and the lower ecotoxicity of the herbicidal compositions according to the invention as compared to those containing a common known adjuvant such as tallow amine ethoxylate.

### EXAMPLES

### Example 1

### Preparation of Esteramine 1

a) Preparation of Tall Oil Fatty Acids Ester with Trilethanolamine

In a reaction vessel equipped with heating, stirrer, thermometer, a system of introduction of the reagents, connected to a cooler provided of collector of water, tall oil fatty acids (1650 g; resin acids content: 2 wt %) and triethanolamine (840 g) are added. The reaction mixture is slowly heated to 180° C. under stirring and nitrogen flow. The reaction mixture is maintained at 180-185° C. until the acid number reaches a value under 5 mg KOH/g.

b) Ethoxylation

In a stirred stainless steel reactor equipped for temperature measurement and control, pressure measurement, vacuum and inert gas purging, sampling and for introduction of ethylene oxide as a liquid, the ester obtained in the step a) (965 g) is added at 60° C. The reactor is heated to 115° C. and maintained under vacuum and nitrogen flow for 1 hour, then cooled to 80° C. Potassium hydroxide (35% wt) in aqueous solution (8 g) is added, the reactor content is heated to 130° C. and maintained under vacuum and nitrogen flow for 45 minutes to reduce its moisture content to less than 0.1%. The reactor is pressurized with nitrogen to 110-140 kPa and heated to 150° C. Ethylene oxide (2001 g) is then added while the temperature is maintained at 150-160° C. The reaction mixture is maintained for 30 minutes at reaction temperature, then it is cooled to 80° C. and acetic acid (80% wt) in aqueous solution (4 g) is added.

### Example 2

### Preparation of Esteramine 2

a) Preparation of Ethoxylated Triethanolamine

In a stirred stainless steel reactor equipped for temperature measurement and control, pressure measurement, vacuum and inert gas purging, sampling and for introduction of ethylene oxide as a liquid, triethanolamine (860 g) and sodium methylate (30 wt %) in methanol solution (20 g) are added. The reactor is pressurized, then vented three times to remove atmospheric oxygen. The reactor is heated to 90° C. and maintained under vacuum and nitrogen flow for 30 minutes. The reactor is pressurized with nitrogen to 110-140 kPa and heated to 125° C. Ethylene oxide (4904 g) is then added while the temperature is maintained at 125-130° C. The reaction mixture is maintained for 30 minutes at reaction temperature, then it is cooled to 80° C. and acetic acid (80% wt) in aqueous solution (4 g) is added.

b) Preparation of Tall Oil Fatty Acids Ester with Ethoxylated Triethanolamine

In a reaction vessel equipped with heating, stirrer, thermometer, a system of introduction of the reagents, connected to a cooler provided of collector of water, ethoxylated triethanolamine (1754 g) and tall oil fatty acids (965 g; resin acids content: 2 wt %) are added. At about 60° C. p-toluensulphonic acid monohydrate (5.6 g) and hypophosphorous acid (50 wt %) in aqueous solution (1.1 g) are added under stirring. The reaction mixture is slowly heated to 195° C. under stirring and nitrogen flow. The reaction mixture is maintained at 195-200° C. until the acid number reaches a value under 15 mg KOH/g. When the acid number is reached, at a temperature of 195-200° C., vacuum is applied (70±5 mmHg) and the reaction mixture is maintained at this condition until the acid number reaches a value under 10 mg KOH/g.

### Examples 3-5

### Preparation of Concentrated Aqueous Herbicide Compositions of Glyphosate Isopropylamine Salt (Glyphosate IPA)

The compositions of Examples 3-5 were prepared by blending at room temperature an aqueous concentrate of glyphosate IPA (62% wt) with the appropriate amount of ethoxylated esteramine and water, as reported in Table 1. The characteristics of the aqueous concentrated glyphosate compositions are reported in Table 2.

TABLE 1

| | Examples | | |
|---|---|---|---|
| Component (wt %) | 3 | 4 | 5 |
| Esteramine 1 | 2.55 | | |
| Esteramine 2 | | 2.55 | 7.16 |
| Glyphosate IPA (62%) | 67.00 | 67.00 | 67.00 |
| Water | 30.45 | 30.45 | 25.84 |

TABLE 2

| | Examples | | | | | |
|---|---|---|---|---|---|---|
| | 3 | | 4 | | 5 | |
| Glyphosate content (a.e.) | 360 | g/l | 360 | g/l | 360 | g/l |
| Density | 1.17 | g/ml | 1.17 | g/ml | 1.17 | g/ml |

| | | | |
|---|---|---|---|
| Appearance | Clear liquid | Clear liquid | Clear liquid |
| Stability test (7 days at 4° C.) | Stable | Stable | Stable |
| Stability test (14 days at | Stable | Stable | Stable |
| 54° C.) | | | |
| pH | 4.7 | 4.7 | 4.7 |

Bioefficacy Test (Greenhouse Tests)

The compositions of Examples 3-5 were diluted and tested for bioefficacy in greenhouse trials on the following weeds: common barnyard (Echinochloa crus-galli), velvetleaf (Abutilon theophrasti) and lamb's quarters (Chenopodium album). The greenhouse test was performed in comparison with comparative glyphosate compositions, obtained by dilution of analogous concentrated glyphosate compositions containing 2.5 wt % (TAE 1) or 7.0 wt % (TAE 2) of tallow amine ethoxylated with 20 moles of ethylene oxide.

The diluted compositions were tested at the following conditions:
on common barnyard for 3, 7 and 10 days treatments (respectively 3 DAT, 7 DAT and 10 DAT) with 0.75 lb glyphosate (a.e.)/acre (a);
on velvetleaf for 7, 11 and 14 days treatments (respectively 7 DAT, 11 DAT and 14 DAT) with 1 lb glyphosate (a.e.)/acre (a);
on lamb's quarters for 5 and 9 days treatments (respectively 5 DAT, and 9 DAT) with 0.313 lb glyphosate (a.e.)/acre (a).

The spray volume used was 15 gal/a applied through 8002 even flat fan nozzle for 4 replications. The results of the tests are reported as “% control” considering 0% as no control and 100% as total control of the weeds and they are showed in the following tables (Tables 3-5).

TABLE 3

| | % Control on common barnyard | | |
|---|---|---|---|
| Composition | 3 DAT (%) | 7 DAT (%) | 10 DAT (%) |
| Example 3 | 58.0 | 77.8 | 84.5 |
| Example 4 | 57.5 | 78.8 | 85.8 |
| TAE 1* | 56.3 | 80.8 | 87.0 |
| Example 5 | 60.8 | 85.0 | 86.3 |
| TAE 2* | 60.0 | 84.8 | 91.0 |

*Comparative

TABLE 4

| | % Control on velvetleaf | | |
|---|---|---|---|
| Composition | 7 DAT (%) | 11 DAT (%) | 14 DAT (%) |
| Example 3 | 81.0 | 95.0 | 98.0 |
| Example 4 | 83.8 | 97.3 | 97.0 |
| TAE 1* | 84.0 | 97.3 | 99.0 |
| Example 5 | 87.8 | 97.0 | 99.0 |
| TAE 2* | 81.8 | 94.8 | 97.8 |

*Comparative

TABLE 5

% Control on lamb's quarters

| Composition | 5 DAT (%) | 9 DAT (%) |
|---|---|---|
| Example 3 | 69.0 | 86.0 |
| Example 4 | 69.0 | 86.5 |
| TAE 1* | 69.0 | 82.7 |
| Example 5 | 71.7 | 94.5 |
| TAE 2* | 75.9 | 91.3 |

*Comparative

The tests show that the adjuvants according to the invention show substantially the same efficacy compared to a known adjuvant such as tallow amine ethoxylate.

Ecotoxicological Tests

The adjuvants of the invention have a better ecotoxicological profile respect to tallow amine ethoxylated with 20 moles of ethylene oxide (TAE), as shown by the relatively low activity against various algae measured in the tests conducted according to standard method ISO 10253:2006 (Water quality—Marine algal growth inhibition test with Skeletonema costatum and Phaeodactylum tricornutum).

The results of the ecotoxicological tests are reported in Table 6.

TABLE 6

| | | |
|---|---|---|
| Adjuvant | EC₅₀ | EC₉₀₋₁₀₀ |

| | | | | |
|---|---|---|---|---|
| Esteramine 1 | >1.00 | mg/l | >1.00 | mg/l |
| Esteramine 2 | >1.00 | mg/l | >1.00 | mg/l |
| TAE | 0.19 | mg/l | 0.37 | mg/l |

EC50 = effective concentration that inhibits the growth of 50% of algae.
EC90-100 = effective concentration that inhibits the growth of 90-100% of algae.

### Examples 6-14

### Emulsion Stability Test

The suitability of the ethoxylated esteramines of the invention for the use in diluted sprayable herbicidal compositions (tank mixes) was evaluated by conducting an emulsion stability test.

Said test was performed according to the standard method CIPAC MT 36.

The tested products were mixed with methylated soybean oil (MSO) and then diluted with water at a dilution rate of 1%.

The emulsions were considered stable when no phase separation or a negligible amount of cream at the top of the emulsion was observed. The results of the emulsion stability test are reported in Table 7a-b.

In the emulsion stability test the Esteramine 2 showed better performances than commercially available emulsifiers or mixtures thereof and comparable performances to tallow amine ethoxylate.

TABLE 7a

| | Examples | | | | |
|---|---|---|---|---|---|
| Component (wt %) | 6* | 7* | 8* | 9 | 10* |
| MSO | 85 | 85 | 85 | 85 | 80 |
| Emulson AG/18C¹ | 15 | | | | 20 |
| Rolfor TR8 L² | | 15 | | | |
| Exthoylated (40 EO) | | | | | |
| castor oil | | | | | |
| TAE-20³ | | | 15 | | |
| Esteramine 2 | | | | 15 | |
| Emulsion appearance | Separa- | Stable | Stable | Stable | Separa- |
| after 2 hours | tion | | | | tion |
| Emulsion appearance | Separa- | Separa- | Stable | Stable | Separa- |
| after 24 hours | tion | tion | | | tion |

¹Emulson AG/18C = ethoxylated castor oii condensed with olein (Lamberti)
²Rolfor TR8 L = branched fatty alcohol ethoxylate (Lamberti)
³Tallow amine ethoxylate (with 20 moles of ethylene oxide)
*Comparative

TABLE 7b

| | Examples | | | |
|---|---|---|---|---|
| Component (wt %) | 11* | 12* | 13* | 14 |
| MSO | 80 | 80 | 80 | 80 |
| Emulson AG/18C¹ | 10 | 10 | 10 | 10 |
| Rolfor TR8 L² | 10 | | | |
| Exthoylated (40 EO) | | 10 | | |
| castor oil | | | | |
| TAE-20³ | | | 10 | |
| Esteramine 2 | | | | 10 |
| Emulsion appearance | Stable | Stable | Stable | Stable |
| after 2 hours | | | | |
| Emulsion appearance | Separation | Separation | Stable | Stable |
| after 24 hours | | | | |

¹Emulson AG/18C = ethoxylated castor oii condensed with olein (Lamberti)
²Rolfor TR8 L = branched fatty alcohol ethoxylate (Lamberti)
³Tallow amine ethoxylate (with 20 moles of ethylene oxide)
*Comparative

1. An aqueous herbicide composition containing from 1 to 30% by weight of an ethoxylated esteramine wherein said ethoxylated esteramine has the formula (I): 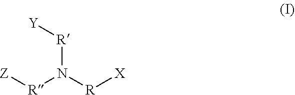
wherein:
a) R, R′ and R″ are each independently alkylene group having from 1 to 8 carbon atoms
b) X, Y and Z are selected among H, O—(CH₂CH₂O)ₙH, O—(CH₂CH₂O)ₙ—COR′″ or O—COR′″ and one of X, Y and Z is O—(CH₂CH₂O)ₙ—COR′″ or O—COR′″
wherein n=1-40, and R′″ is a saturated or unsaturated C₆-C₃₀ alkyl group;
provided that:
i) when one among X, Y or Z is O—(CH₂CH₂O)ₙ—COR′″, the other two substituents are each independently H or O—(CH₂CH₂O)ₙH
ii) when one among X,Y or Z is O—COR′″, the other two substituents are H or O—(CH₂CH₂O)ₙH and at least one of them is O—(CH₂CH₂O)ₙH

2. The aqueous herbicide composition according to claim 1, wherein the ethoxylated esteramine has the formula (I): 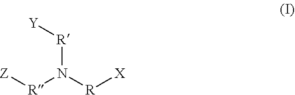
wherein:
a) R, R′ and R″ are each independently alkylene group having 2 carbon atoms
b) X, Y and Z are selected among O—(CH₂CH₂O)ₙH, O—(CH₂CH₂O)ₙ—COR′″ or O—COR′″ and one of X, Y and Z is O—(CH₂CH₂O)ₙ—COR′″ or O—COR′″
wherein n=3-20, and R′″ is a saturated or unsaturated C₁₆-C₂₂ alkyl group;
provided that:
i) when one among X, Y or Z is O—(CH₂CH₂O)ₙ—COR′″, the other two substituents are both O—(CH₂CH₂O)ₙH
ii) when one among X,Y or Z is O—COR′″, the other two substituents are both O—(CH₂CH₂O)ₙH

3. The aqueous herbicide composition according to claim 1, wherein said aqueous herbicide composition contains from 100 to 750 g/l (as acid equivalents) of glyphosate or an agriculturally acceptable salt thereof.

4. The aqueous herbicide composition according to claim 3, wherein said aqueous herbicide composition contains from 300 to 600 g/l (as acid equivalents) of glyphosate or an agriculturally acceptable salt thereof and from 2 to 10% by weight of the ethoxylated esteramine of Formula (I).

5. The aqueous herbicide composition according to claim 3, wherein in Formula (I) R′″ is a saturated or unsaturated alkyl group derived from tall oil.

6. The aqueous herbicide composition according to claim 3 comprising at least 10% by weight of water.

7. The aqueous herbicide composition according to claim 6 comprising from 20 to 40% by weight of water.

8. The aqueous herbicide composition according to claim 3, wherein the glyphosate or agriculturally acceptable salt thereof is the isopropylamine salt of glyphosate or the potassium salt of glyphosate.

9. The aqueous herbicide composition according to claim 3 further containing a water-soluble organic solvent.

10. The aqueous herbicide composition according to claim 3 further containing one or more additives selected among antifoam agents, antifreeze agents, dyes, stabilizers, buffers, thickeners, flow enhancers, wetting agents, lubricants, fillers, drift control agents, deposition enhancers, evaporation retardants.

11. A method for killing or controlling the growth of weeds which includes applying on the fields a diluted aqueous herbicidal composition containing from 0.01 to 3% by weight of glyphosate (a.e.) or an agriculturally acceptable salt thereof and an ethoxylated esteramine of formula (I) as adjuvant, in an amount sufficient to kill or control the growth of the weeds.

12. The aqueous herbicide composition according to claim 1, wherein said aqueous herbicide composition is a diluted sprayable herbicidal composition (tank mix) comprising from 0.01 to 10% by weight of at least one herbicide and from 0.001 to 5% by weight of an ethoxylated esteramine of formula (I).

13. The aqueous herbicide composition according to claim 12, wherein said herbicide is glyphosate.
